(19) United States
(12) Patent Application Publication
(10) Pub. No.: US 2023/0404026 A1
(43) Pub. Date: Dec. 21, 2023

(54) BALE CUTTING ASSEMBLY FOR AGRICULTURAL MIXER APPARATUS

(71) Applicant: NOLAN DEN BOER, ROCK VALLEY, IA (US)

(72) Inventor: NOLAN DEN BOER, ROCK VALLEY, IA (US)

(21) Appl. No.: 18/197,937

(22) Filed: May 16, 2023

Related U.S. Application Data
(60) Provisional application No. 63/353,961, filed on Jun. 21, 2022.

(51) Int. Cl. A01K 5/00

(52) U.S. Cl. CPC A01K 5/004

(57) ABSTRACT

A bale cutting assembly for mounting on an agricultural mixer apparatus includes a cutting knife for cutting material located in the tub interior of the mixer apparatus and having a knife edge. The cutting knife being configured to extend in a knife plane oriented substantially parallel to a plane defined by flighting of the auger of the mixer apparatus at a location at which the bale cutting assembly is mounted on the flighting. The bale cutting assembly further including a bale slicer for cutting material located in the tub interior and having a slicer edge. The bale slicer may be positionable adjacent to the cutting knife in a position superior to the cutting knife. The bale slicer may have a portion with the slicer edge, and the portion may be oriented in a slicer plane angled upwardly with respect to the knife plane.

### REFERENCE TO RELATED APPLICATIONS

This application claims the priority benefit of U.S. Provisional Patent Application No. 63/353,961, filed Jun. 21, 2022, the entirety of the disclosure of which is hereby incorporated by reference.

### BACKGROUND

### Field

The present disclosure relates to mixing apparatus and more particularly pertains to a new bale cutting assembly for agricultural mixer apparatus for facilitating cutting and mixing of materials.

### SUMMARY

In one aspect, the present disclosure relates to a bale cutting assembly for mounting on flighting of an auger of an agricultural mixer apparatus to be moved by rotation of the auger about a rotation axis in an interior of a tub of the apparatus, and the tub may be characterized by having a perimeter wall and the flighting may be characterized by having an upper surface and an outer edge. The bale cutting assembly may comprise a cutting knife having a knife edge. The knife edge of the cutting knife may be configured to extend from the outer edge of the flighting in a knife plane oriented substantially parallel to a plane defined by the flighting at a location at which the bale cutting assembly is mounted on the flighting when the assembly is mounted on the auger to contact plant material located in the interior of the tub between the outer edge of the flighting and the perimeter wall of the tub. The bale cutting assembly may further comprise a bale slicer having a slicer edge. The bale slicer may be positioned adjacent to the cutting knife in a position superior to the cutting knife when the assembly is mounted on the flighting of the auger. A portion of the bale slicer may have the slicer edge being oriented in a slicer plane angled upwardly with respect to the knife plane such that the slicer edge is angled upwardly with respect to the flighting to contact plant material moving laterally outward with respect to the rotation axis and relative to the upper surface of the flighting.

In another aspect, the disclosure relates to a system which may include an agricultural mixer apparatus configured to cut materials. The mixer apparatus may comprise a frame, and a tub for holding the materials to be mixed. The tub may be mounted on the frame, and may define an interior for receiving the materials to be cut, and may include a perimeter wall. The mixer apparatus may further comprise an auger positioned in the interior of the tub, and the auger may be rotatable about a rotation axis and have flighting with an outer edge. The system may further include a bale cutting assembly mounted on the flighting of the auger of the mixer apparatus to be moved by the auger in the interior of the tub of the apparatus. The bale cutting assembly may comprise a cutting knife having a knife edge, and the knife edge of the cutting knife may extend from the outer edge of the flighting in a knife plane oriented substantially parallel to a plane defined by the flighting at a location at which the bale cutting assembly is mounted on the flighting to contact plant material located in the interior of the tub between the outer edge of the flighting and the perimeter wall of the tub. The bale cutting assembly may further comprise a bale slicer having a slicer edge, and the bale slicer may be positioned adjacent to the cutting knife in a position superior to the cutting knife. A portion of the bale slicer may have the slicer edge being oriented in a slicer plane angled upwardly with respect to the knife plane such that the slicer edge is angled upwardly with respect to the flighting to contact plant material moving laterally outward with respect to the rotation axis and relative to the upper surface of the flighting.

In still another aspect, the disclosure relates to a bale slicer for mounting on flighting of an auger of an agricultural mixer apparatus with a cutting knife to be moved by rotation of the auger about a rotation axis in an interior of a tub of the apparatus. The bale slicer may comprise a base portion which is configured to mount on the flighting of the auger in a first plane oriented substantially parallel to a plane defined by the flighting at a location at which the bale slicer is mounted on the flighting when the bale slicer is mounted on the flighting to contact plant material located in the interior of the tub between the outer edge of the flighting and the perimeter wall of the tub a knife plane of the cutting knife. The bale slicer may further comprise a slicer portion forming a serrated slicer edge, and the slicer edge being located in a slicer plane of the slicer portion. The slicer plane of the slicer edge may be angled upwardly at a slicer angle with respect to the knife plane such that the slicer edge is angled upwardly with respect to the flighting when the base portion is mounted on the flighting to contact plant material moving laterally outward with respect to the rotation axis and relative to an upper surface of the flighting.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic side view of a portion of an embodiment of a system with a new bale cutting assembly and agricultural mixer apparatus according to the present disclosure, with a portion of the tub of the feed mixer removed to reveal detail of the system and a bale shown entering the tub.

FIG. 2 is a schematic side view of an auger of the feed mixing apparatus isolated from the remainder of the mixing apparatus with the bale cutting assembly mounted on the auger in a first location, according to an illustrative embodiment.

FIG. 3 is a schematic side view of the auger of the feed mixing apparatus isolated from the remainder of the mixing apparatus with the bale cutting assembly mounted on the auger in a second location, according to an illustrative embodiment.

FIG. 4 is a schematic side view of the auger of the feed mixing apparatus isolated from the remainder of the mixing apparatus with the bale cutting assembly mounted on the auger in a third location, according to an illustrative embodiment.

FIG. 5 is a schematic perspective view of the bale cutting assembly shown mounted in a first optional position on a fragmentary portion of the flighting of the auger, according to an illustrative embodiment.

FIG. 6A is a schematic perspective view of the bale cutting assembly shown mounted in a second optional position on a fragmentary portion of the flighting of the auger, according to an illustrative embodiment.

FIG. 6B is a schematic perspective view of the bale cutting assembly shown in FIG. 6A mounted in the second optional position on a fragmentary portion of the flighting of the auger, according to an illustrative embodiment.

FIG. 7 is a schematic upper perspective view of an embodiment of the bale cutting assembly, with one optional bale slicer configuration, according to an illustrative embodiment.

FIG. 8 is a schematic upper perspective view of an optional configuration of a bale slicer of the bale cutting assembly, according to an illustrative embodiment.

FIG. 9 is a schematic perspective exploded view of the embodiment of the bale slicer shown in FIG. 7, according to an illustrative embodiment.

FIG. 10 is a schematic upper perspective view of another configuration of a bale slicer of the bale cutting assembly, according to an illustrative embodiment.

FIG. 11 is a schematic upper perspective view of yet another configuration of a bale slicer of the bale cutting assembly, according to an illustrative embodiment.

FIG. 12 is a schematic upper perspective view of still yet another configuration of the bale slicer, according to an illustrative embodiment.

FIG. 13 is a schematic perspective exploded view of the embodiment of the bale slicer shown in FIG. 12, according to an illustrative embodiment.

FIG. 14 is a schematic upper perspective view of the bale slicer, according to an illustrative embodiment.

FIG. 15 is a schematic lower perspective view of the bale slicer shown in FIG. 14, according to an illustrative embodiment.

### DETAILED DESCRIPTION

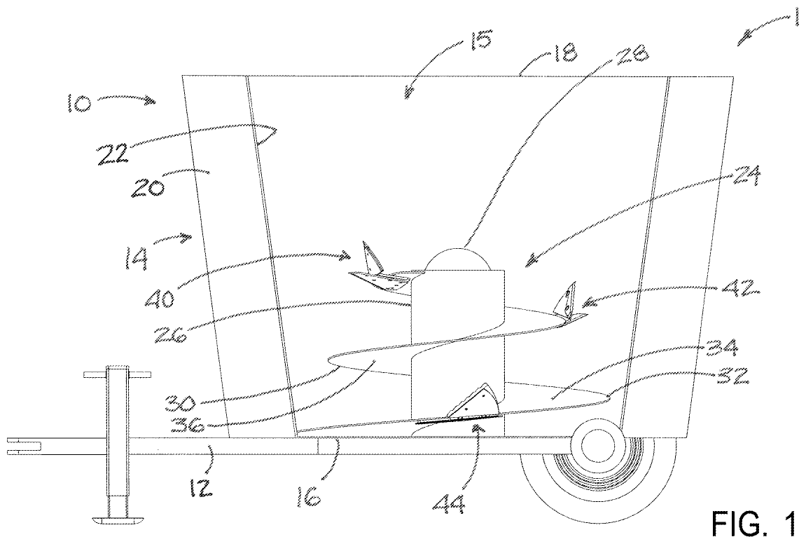

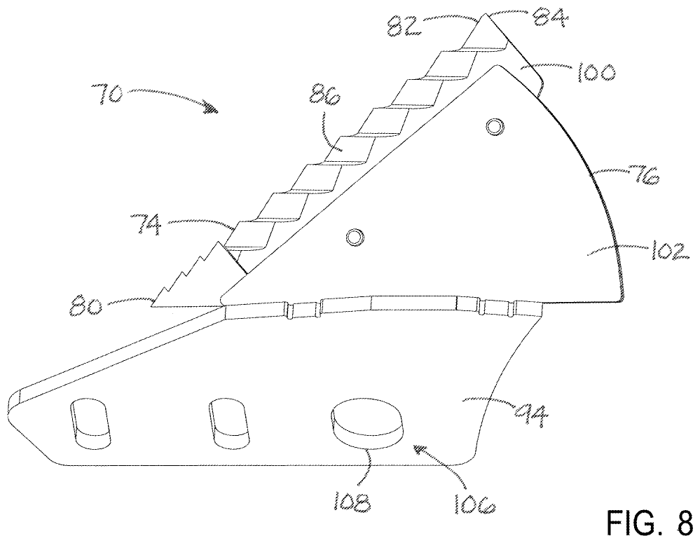

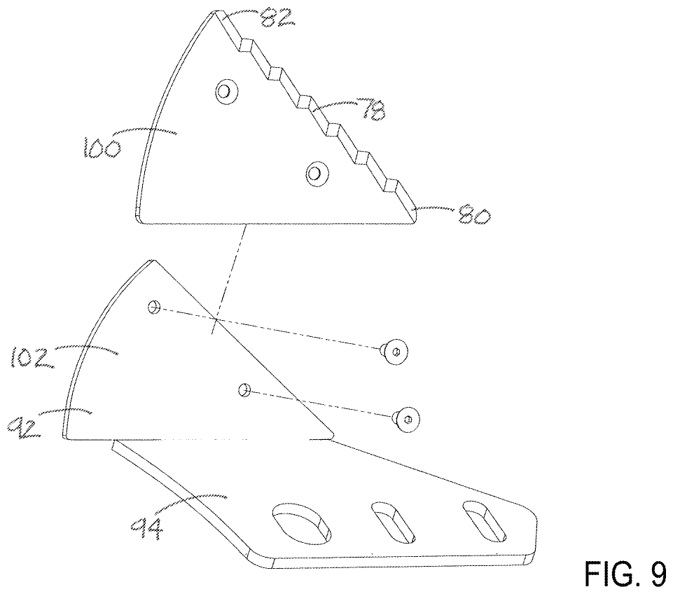

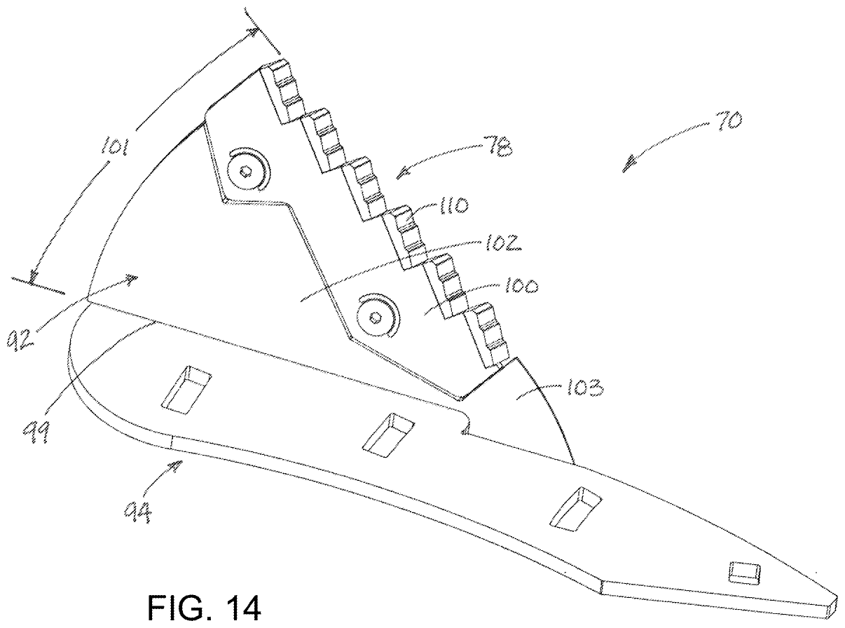

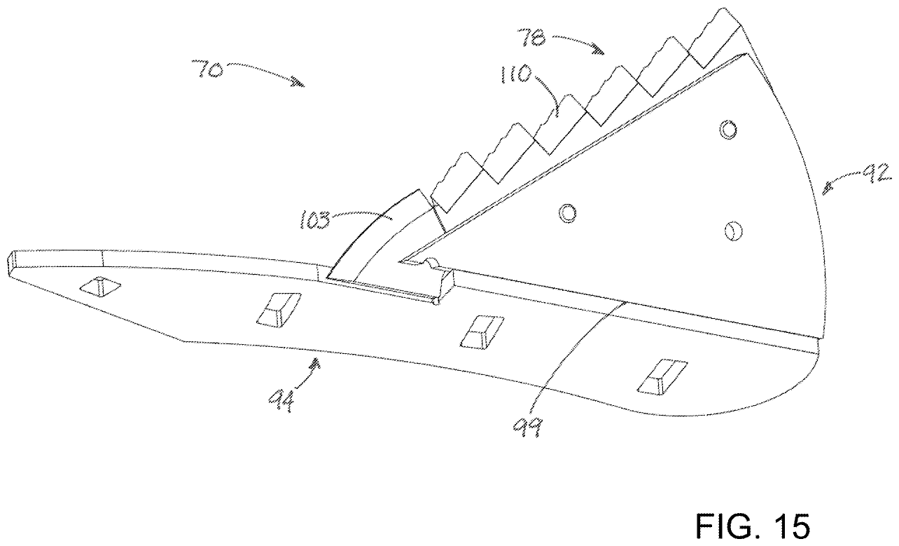

With reference now to the drawings, and in particular to FIGS. 1 through 15 thereof, a new bale cutting assembly for agricultural mixer apparatus embodying the principles and concepts of the disclosed subject matter will be described.

The applicant has recognized that the use of knives or other structures mounted on the flighting of augers of mixing apparatus is highly useful for cutting or chopping (and mixing) materials placed in the mixing apparatus tub. The applicant has also recognized that the typical auger-mounted knives may have limited reach or influence on materials in the tub, typically based upon the current positions of the materials in the tub. Despite the churning and movement of the materials in the tub caused by the helical flighting of the rotating auger, these limitations of the knives may prolong the length of time of mixer operation on the materials that is required to obtain the desired degree of mixing or size reduction in the materials. For example, conventional knives may more effectively engage the materials that are located adjacent to the walls of the tub, with more limited influence on materials that are moved on and over and off of the flighting of the auger.

As a particular example, processing some materials, such as material mixtures containing a high degree of hay, may be problematic using the known knives alone. The hay needs to be made shorter in length during processing, but the hay tends to “ball up” and the resulting balls of hay tend to roll along the inner surface of the perimeter wall of the tub outside of significant influence of known knife designs.

The applicant has developed a bale cutting assembly which may retain the effective influence of knives while enhancing the cutting influence of the materials moving over the flighting and moving off of the outer edge of the flighting to advantageously reduce the operational time necessary to achieve the desired degree of cutting and/or mixing.

In one aspect, the disclosure relates to a system 1 which may be employed or suitable for cutting and/or mixing materials. The system 1 may broadly include an agricultural mixer apparatus 10 which is configured to mix ingredients for animal feed, but may also have other capabilities for cutting and intermixing various components of the feed. Typically, the ingredients may include fibrous plant material which may be bound in a bale when introduced into the mixer apparatus 10.

In illustrative mixer apparatus 10 may include a frame 12 which may be configured for moving across a ground surface, such as being provided with an axle being mounted on the frame, and wheels mounted on opposite ends of the axle (see, e.g., FIG. 1). Optionally, the frame 12 may be configured for more stationary operation. The mixer apparatus 10 may also include a tub 14 for receiving and holding the materials to be cut and/or mixed, such as the ingredients of the animal feed. The tub 14 is typically mounted on the frame 12, and defines an interior 15 into which the materials are introduced for reducing in size and/or comminuting during apparatus operation. The interior 15 is at least partially bounded by a floor 16 of the tub located at a lower portion of the interior 15. The tub 14 may have an opening 18 located at an upper portion of the interior 15, opposite of the location of the floor. The tub 14 is typically at least partially formed by a perimeter wall 20 which extends upwardly from the floor 16 toward the opening 18, and extends about the interior 15 to bound the interior in the horizontal direction. The perimeter wall 20 has an inward surface 22 which faces the interior 15. Typically, although not necessarily, a cross-sectional area of the interior 15 in a horizontally extending plane increases in size toward the opening 18 and decreases in size toward the floor 16.

The mixer apparatus 10 may further include an auger 24 positioned in the interior 15 of the tub that extends upwardly from the floor 16 of the tub toward the opening 18 of the tub. The auger 24 may be rotatably mounted on the frame 12 to rotate with respect to the tub 14. Aspects of the auger 24 may cause movement of the contents of the tub in the interior 15 of the tub, and may also facilitate reduction in the size of the pieces of the contents, such as the size of the pieces of the fibrous plant material. In general, the auger 24 may rotate with respect to the frame 12 and the tub 14 about a rotation axis 25. The auger 24 may comprise a central mast 26 rotatably mounted on the frame 12 to rotate about the axis 25, and the mast 26 may extend upwardly from the floor 16 of the tub. The central mast 26 may have an upper tip 28 and a peripheral surface which may be generally cylindrical in shape. The auger 24 may also comprise flighting 30 mounted on the central mast 26 to rotate with the mast. The flighting 30 may have a generally helical configuration that extends about the central mast, with an upper end of the flighting 30 being positioned proximate to the tip 28 and a lower end of the flighting being positioned proximate to the floor 16. The upper end of the flighting may be located toward the opening 18. The flighting 30 has an outer edge 32 which has a generally helical path about the rotation axis 25. The flighting 30 has an upper surface 34 oriented generally in an upward direction for the opening 18 and a lower surface 36 oriented generally in a downward direction toward the floor 16. The outer edge 32 may extend between the upper and lower portions of the flighting in the helical path. The flighting 30 typically has an uppermost circumvolution located toward the upper tip 28 of the central mast. The flighting 30 may have at least one mounting hole formed therein for mounting various elements adjacent to the outer edge of the flighting.

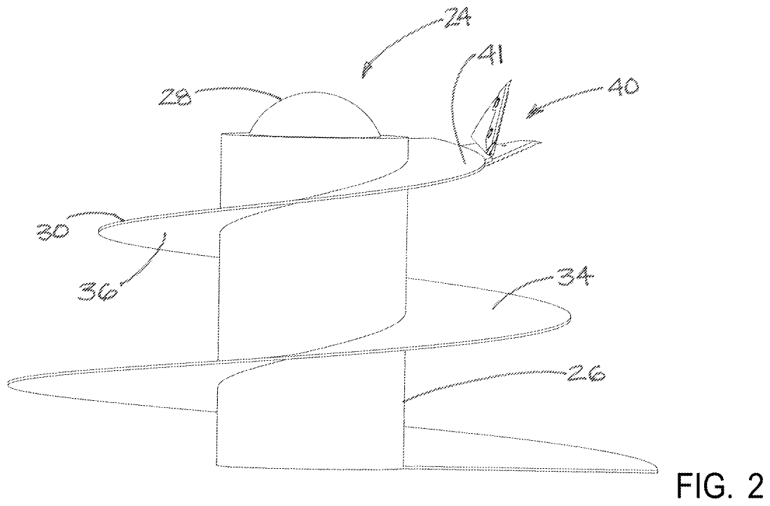

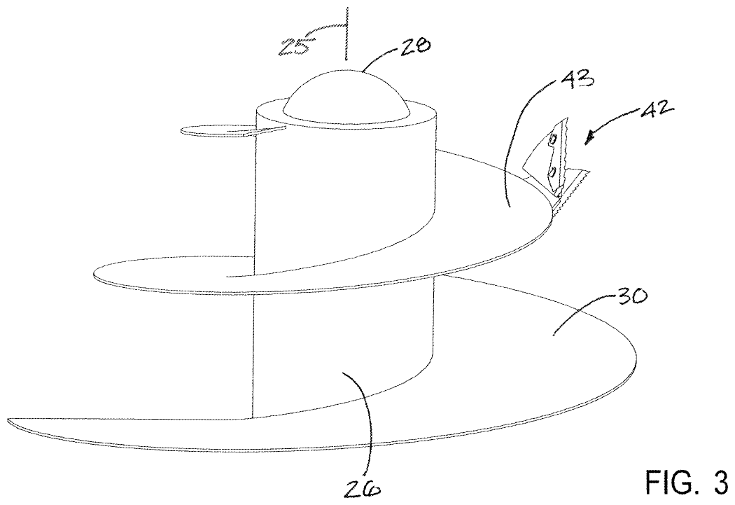

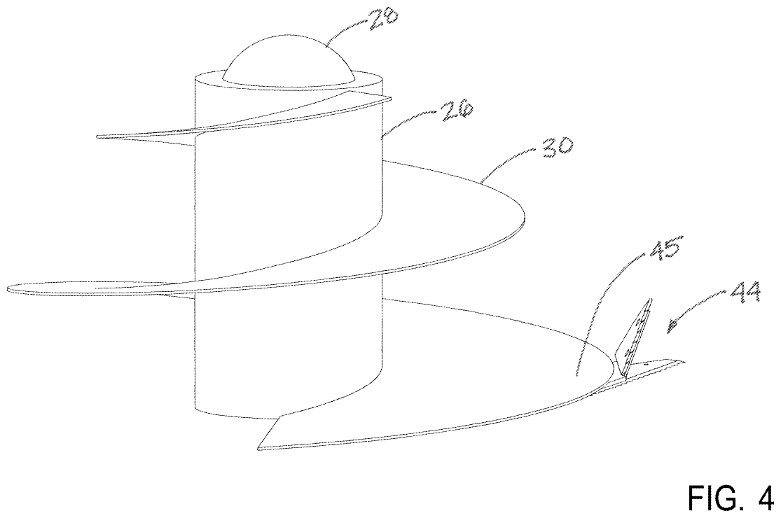

The system 1 may also include at least one bale cutting assembly 40 which is mounted on the auger 24 in a manner such that the assembly 40 is moved by the auger through the interior of the tub. The bale cutting assembly 40 is typically moved along a substantially circular path in the tub interior 15 by the rotation of the auger flighting 30 about the axis 25, and the circular path may be in a plane that is substantially horizontally oriented. The bale cutting assembly 40 may be mounted on the auger at a location 41 on the auger along the outer edge 32 of the flighting of the auger. In some embodiments, a plurality of cutting assemblies 40, 42, 44 may be utilized in the system, and may include a first bale cutting assembly 40 mounted on the auger at a first location 41 on the auger (see, e.g., FIGS. 1 and 2). The plurality of cutting assemblies may also include a second bale cutting assembly 42 which is mounted on the auger at a second location 43 on the auger (see FIGS. 1 and 3), and may further include a third bale cutting assembly 44 which is mounted on the auger at a third location 45 (see FIGS. 1 and 4). Optionally, still further bale cutting assemblies may be utilized. For the purposes of this disclosure, a single bale cutting assembly will be described with the understanding that other bale cutting assemblies may or may not have similar or identical features and characteristics. In general, each of the bale cutting assemblies may have an inward end 46 which is oriented toward the mast 26 of the auger and an outward end 38 which is oriented away from the mast. In embodiments, the inward end 46 may be positioned adjacent to the flighting 30 of the auger and the outward end may be positioned away from the flighting and beyond the outer edge 32 to protrude from the flighting into the portion of the interior 15 located between the flighting and the perimeter wall 20 of the tub.

Some embodiments of the bale cutting assembly 40 (or multiple assemblies 40, 42, 44) may include a cutting knife 50 configured to contact and cut plant material located in the interior 15 of the tub. The cutting knife 50 may be configured to cut material moving downwardly in the tub interior 15 along or adjacent to the inward surface 22 of the perimeter wall. The cutting knife 50 has a first face 52 and a second face 54 opposite of the first face. The first face 52 may be oriented upwardly when the knife 50 is mounted on the auger and the second face 54 may be oriented downwardly when the knife is mounted on the auger. The cutting knife 50 may extend in a knife plane 56 which typically may be oriented substantially parallel to a plane defined by the flighting of the auger at or local to the respective location at which the bale cutting assembly 40 is mounted on the flighting 30. The knife 50 may be formed by a plate which has a substantially uniform thickness. The cutting knife 50 has a knife edge 60, and the knife edge is typically forwardly oriented with respect to the direction of movement of the bale cutting assembly 40 when the auger 24 is rotated during operation of the apparatus 10. In some embodiments, at least a portion of the knife edge 60 is a sharpened edge with at least a portion of the knife edge tapering thinner in thickness to a thin thickness at the forwardmost extent of the edge. The cutting knife 50 may have a trailing edge 62 which is oriented away from the forward direction. The knife edge 60 and the trailing edge 52 may lie in the knife plane 56. The cutting knife 50 may include a knife mounting structure 64 configured to mount the cutting knife on the flighting of the auger, and illustratively the structure 64 may comprise a plurality of knife mounting holes 66 which are aligned or alignable with the mounting holes 48 in the flighting 30 of the auger. A fastener may pass through the knife mounting holes 66 and the mounting holes 48 of the auger to fasten the cutting knife to the auger.

Embodiments of the bale cutting assembly 40 (or multiple assemblies 40, 42, 44) may include a bale slicer 70 configured to contact and cut plant material located in the interior of the tub 14. The bale slicer 70 of the bale cutting assembly may be utilized alone or in combination with the cutting knife 50, which may provide unique benefits to the handling of the materials in the tub interior 15. Advantageously, while the cutting knife 50 may be particularly effective for cutting material in the tub interior which moves downwardly between the outer edge 32 of the flighting and the inward surface 22 of the perimeter wall 20 of the tub, the bale slicer 70 may be particularly effective for cutting material moving in a direction laterally on the upper surface 34 of the flighting outwardly from the central mast 26 of the auger, and outwardly with respect to the rotation axis 25, which may include the material moving upwardly in the tub interior under the influence of the auger such as the material being carried upwardly on the upper surface 34.

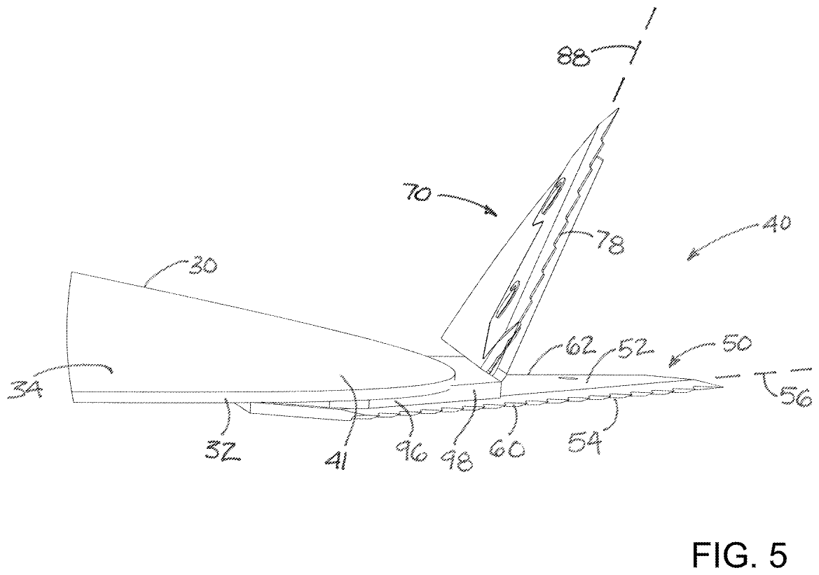

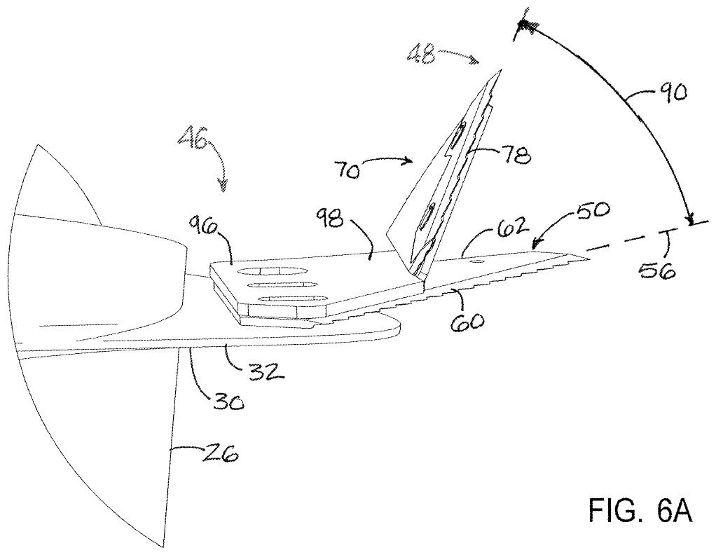

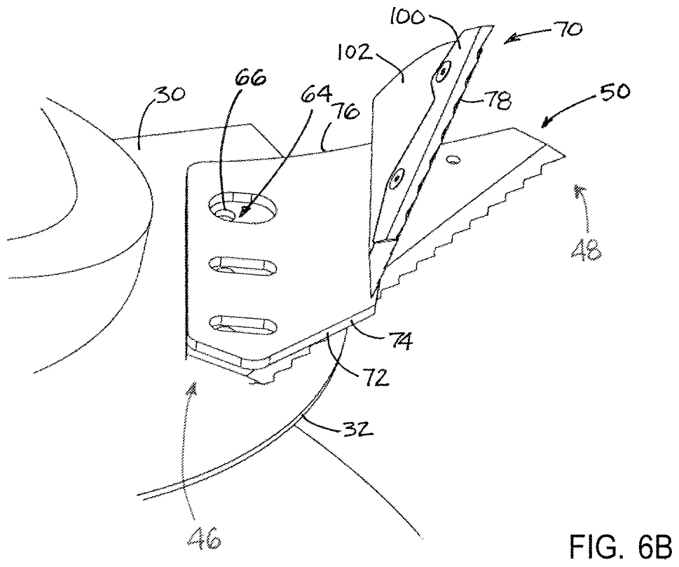

The bale slicer 70 may be positioned adjacent to the cutting knife 50, and may be positioned superiorly to or above the cutting knife. In some of the illustrative embodiments, such as shown in FIG. 5, the bale slicer 70 may be positioned between the cutting knife 50 and the flighting 30 of the auger. In other illustrative embodiments, such as shown in FIG. 6, the cutting knife 50 may be positioned between the bale slicer 70 and the flighting 30 of the auger.

The bale slicer 70 has a perimeter 72 which may include a leading perimeter portion 74 which may be oriented in the forward direction of movement of the slicer when the bale cutting assembly 40 is mounted on the auger 24. The perimeter 72 may also include a trailing perimeter portion 76 which may be oriented away from the direction of movement of the slicer when the bale cutting assembly is mounted on the auger.

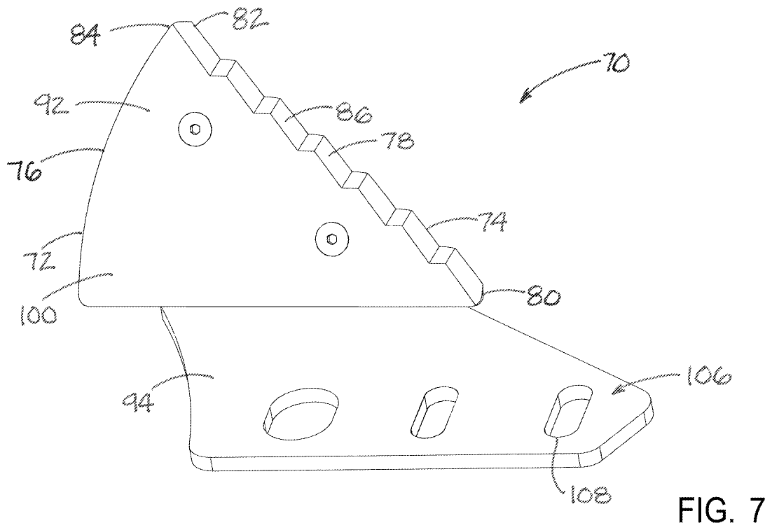

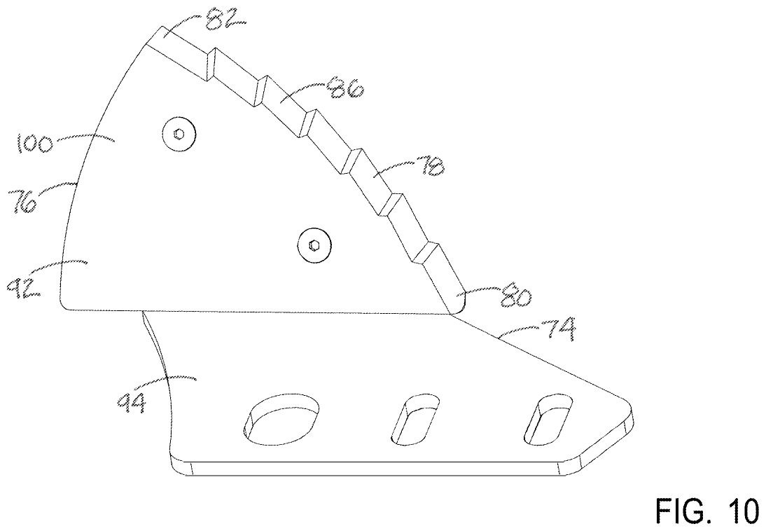

The perimeter 72 of the bale slicer 70, such as a leading perimeter portion 74, may have a slicer edge 78 which is forwardly oriented with respect to the direction of movement of the bale cutting assembly. The slicer edge 78 has opposite ends which may include an inboard end 80 which may be positioned adjacent to the knife plane 56 and an outboard end 82 which may be located a distance above the knife plane. The outboard end 82 of the slicer edge may form a tip 84 of the bale slicer, and the outboard end 82 of the edge may be located on the portion of the slicer that is located furthest from the knife plane. At least a portion of the slicer edge 78 may comprise a sharpened edge, and illustratively substantially an entirety of the edge 78 between the inboard 80 and outboard 82 ends may be sharpened such that the slicer tapers to a thinner thickness at the forwardmost extent of the edge. In some embodiments, the slicer edge 78 may be serrated with a plurality of edge segments 86. In some illustrative examples, the slicer edge 78 may extend in a substantially linear manner between the inboard 80 and outboard 82 ends (see FIGS. 7 through 9) such that the edge segments are oriented substantially parallel to each other. In other illustrative examples, the slicer edge 78 may extend in a substantially arcuate manner between the ends 80, 82 (see FIG. 10) such that the edge segments 86 are oriented at angles with respect to each other.

Embodiments of the bale slicer 70 may have at least a portion which is oriented in a slicer plane 88. The slicer plane 88 may be oriented at a slicer angle 90 with respect to the knife plane 56, and typically the slicer angle is an oblique angle, such as illustrated in FIG. 6A. In some implementations of the disclosure, the slicer angle 90 may be equal, or substantially equal, to the angle of the inward surface 23 of the perimeter wall of the tub. Thus, the orientation of the slicer plane 88 may be substantially parallel to the orientation of the inward surface 23 of the perimeter wall of the tub. Illustratively, in some embodiments the slicer angle 90 may measure from approximately 30 degrees to approximately 90 degrees, and in some embodiments the slicer angle may measure from approximately 45 degrees to approximately 75 degrees. In one highly suitable embodiment, the slicer angle 90 measures approximately 68 degrees.

In some embodiments, the bale slicer 70 has a slicer portion 92 which is oriented in the slicer plane 88, and the slicer edge 78 may be formed on the slicer portion. The bale slicer 70 may also have a base portion 94 which is mounted or mountable on the flighting 30 of the auger. The base portion 94 may be oriented substantially parallel to a plane that is defined by the flighting 30 of the auger at the location on the auger at which the bale cutting assembly is mounted on the flighting. A first section 96 of the base portion may be positioned adjacent to the flighting 30, and may be positioned adjacent to the cutting knife 50. A second section 98 of the base portion may extend from the first section 96 of the base portion and may extend beyond the outer edge 32 of the flighting.

In some illustrative embodiments, the slicer portion 92 and the base portion 94 may be formed by a plate or plates, such as a single plate bent along a crease 99 or multiple plates bonded or welded together at the crease 99. The crease 99 may thus be positioned between the slicer 92 and base 94 portions, and may be linear in extent. The crease 99 and the slicer edge 78 may define a slicer edge angle 101 which may be acute, and illustratively the slicer edge angle may range from approximately 30 degrees to approximately 60 degrees.

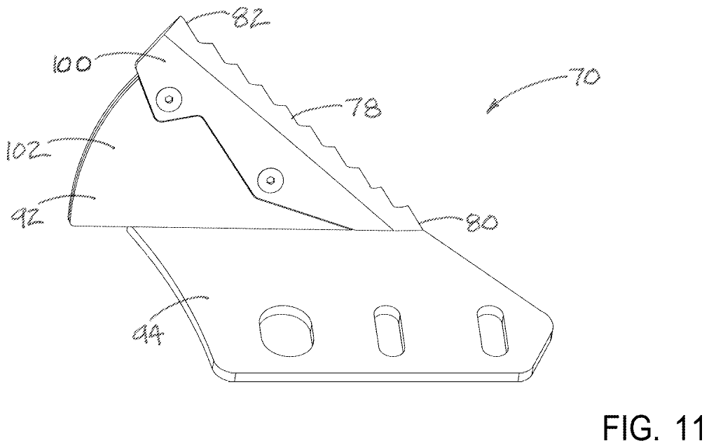

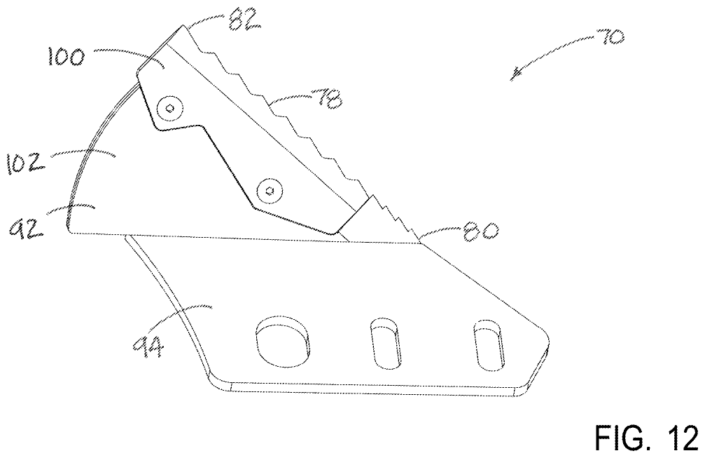

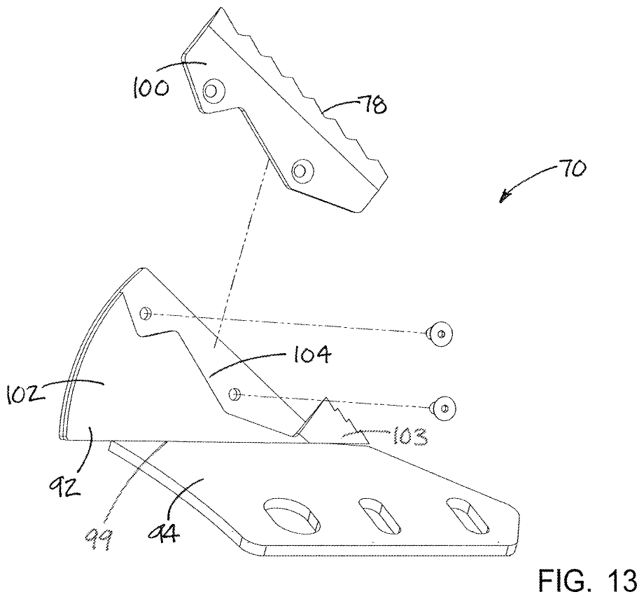

In some embodiments, the slicer portion 92 may comprise a slicer element 100 and a mount element 102, which may be separable parts of the portion 92. The slicer element 100 may be removably mounted on the mount element 102, and the mount element may form an inset seat 104 for the slicer element to be positioned in. The slicer element 100 may have at least a portion of the slicer edge 78 formed thereon. In some embodiments, a portion of the slicer edge 78 may be located on the slicer element 100 and a portion 103 of the slicer edge may be located on the mount element 102 (see FIGS. 12 and 13). In such embodiments, sections of the surface of the portion 103 of the slicer edge may be coated with a wear resistant material, such as a carbide containing material. In other embodiments, the slicer element 100 may form an entirety of the slicer edge 78 (see, e.g., FIG. 11). In still further embodiments, the slicer edge 78, and in some implementations the slicer element 100, may include a plurality of segment inserts 110 arranged to form the edge 78, and each of the inserts 110 may be formed of a material with hardened characteristics portion 92. An illustrative example of a suitable construction and technology for this is disclosed in U.S. Pat. No. 11,044,852 of Kooima et al., which is hereby incorporated by reference in its entirety.

The bale slicer 70 may have a slicer mounting structure 106 which is configured to mount the bale slicer on the flighting 30 of the auger, and the structure 106 may be located on the base portion 94 of the of the slicer. Illustratively, the slicer mounting structure 106 may comprise a plurality of slicer mounting holes 108 which are aligned or alignable with the knife mounting holes 66 of the cutting knife and the mounting holes 38 in the flighting 30 of the auger. Optionally, the slicer mounting holes 108 may be elongated to form slots to provide a degree of adjustability of the position of the bale slicer 70 with respect to the flighting 30 and/or the cutting knife 50.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

I claim:

1. A bale cutting assembly for mounting on flighting of an auger of an agricultural mixer apparatus to be moved by rotation of the auger about a rotation axis in an interior of a tub of the apparatus, the tub being characterized by having a perimeter wall and the flighting being characterized by having an upper surface and an outer edge, the bale cutting assembly comprising:
a cutting knife having a knife edge, the knife edge of the cutting knife being configured to extend from the outer edge of the flighting in a knife plane oriented substantially parallel to a plane defined by the flighting at a location at which the bale cutting assembly is mounted on the flighting when the assembly is mounted on the auger to contact plant material located in the interior of the tub between the outer edge of the flighting and the perimeter wall of the tub; and
a bale slicer having a slicer edge, the bale slicer being positioned adjacent to the cutting knife in a position superior to the cutting knife when the assembly is mounted on the flighting of the auger, a portion of the bale slicer having the slicer edge being oriented in a slicer plane angled upwardly with respect to the knife plane such that the slicer edge is angled upwardly with respect to the flighting to contact plant material moving laterally outward with respect to the rotation axis and relative to the upper surface of the flighting.

2. The bale cutting assembly of claim 1 wherein the cutting knife has a first face oriented upwardly when the bale cutting assembly is mounted on the flighting of the auger, at least a portion of the bale slicer being located above the first face of the cutting knife when the assembly is mounted on the flighting of the auger.

3. The bale cutting assembly of claim 1 wherein the knife plane of the cutting knife diverges from the slicer plane of the bale slicer.

4. The bale cutting assembly of claim 3 wherein the knife plane diverges from the slicer plane at a slicer angle of approximately 30 degrees to approximately 90 degrees.

5. The bale cutting assembly of claim 1 wherein the bale cutting assembly has an inward end for positioning toward the rotation axis when the assembly is mounted on the flighting of the auger and an outward end for positioning away from the rotation axis, the knife edge of the cutting knife and the slicer edge of the bale slicer converging toward the inward end and diverging toward the outboard end.

6. The bale cutting assembly of claim 1 wherein the bale slicer has:
a base portion configured to mount on the flighting of the auger in a plane oriented substantially parallel to the knife plane of the cutting knife; and
a slicer portion forming the slicer edge and being oriented in the slicer plane at a slicer angle with respect to the base portion.

7. The bale cutting assembly of claim 6 wherein the slicer portion of the bale slicer includes a slicer element and a mount element, the slicer element being removably mounted on the mount element.

8. A system comprising:
an agricultural mixer apparatus configured to cut materials, the mixer apparatus comprising:
a frame;
a tub for holding the materials to be mixed, the tub being mounted on the frame, the tub defining an interior for receiving the materials to be cut, the tub including a perimeter wall; and
an auger positioned in the interior of the tub, the auger being rotatable about a rotation axis, the auger having flighting with an outer edge; and
a bale cutting assembly mounted on the flighting of the auger of the mixer apparatus to be moved by the auger in the interior of the tub of the apparatus, the bale cutting assembly comprising:
a cutting knife having a knife edge, the knife edge of the cutting knife extending from the outer edge of the flighting in a knife plane oriented substantially parallel to a plane defined by the flighting at a location at which the bale cutting assembly is mounted on the flighting to contact plant material located in the interior of the tub between the outer edge of the flighting and the perimeter wall of the tub; and
a bale slicer having a slicer edge, the bale slicer being positioned adjacent to the cutting knife in a position superior to the cutting knife, a portion of the bale slicer having the slicer edge being oriented in a slicer plane angled upwardly with respect to the knife plane such that the slicer edge is angled upwardly with respect to the flighting to contact plant material moving laterally outward with respect to the rotation axis and relative to the upper surface of the flighting.

9. The system of claim 8 wherein the cutting knife has a first face oriented upwardly and at least a portion of the bale slicer being located above the first face of the cutting knife.

10. The system of claim 8 wherein the knife plane of the cutting knife diverges from the slicer plane of the bale slicer.

11. The system of claim 10 wherein the knife plane diverges from the slicer plane at a slicer angle of approximately 30 degrees to approximately 90 degrees.

12. The system of claim 8 wherein the bale cutting assembly has an inward end positioned toward the rotation axis and an outward end positioned away from the rotation axis, the knife edge of the cutting knife and the slicer edge of the bale slicer converging toward the inward end and diverging toward the outboard end.

13. The system of claim 8 wherein the bale slicer has:
a base portion mounted on the flighting of the auger in a plane oriented substantially parallel to the knife plane of the cutting knife; and
a slicer portion forming the slicer edge and being oriented in the slicer plane at a slicer angle with respect to the base portion.

14. The system of claim 13 wherein at least a section of the base portion of the bale slicer extends beyond the outer edge of the flighting of the auger.

15. The system of claim 8 wherein the slicer portion of the bale slicer includes a slicer element and a mount element, the slicer element being removably mounted on the mount element.

16. The system of claim 8 wherein a plurality of the bale cutting assemblies are mounted on the flighting of the auger at different radial positions about the rotation axis of the auger and at different elevations with respect to a floor of the tub.

17. The system of claim 8 wherein the bale slicer is positioned between the cutting knife and the flighting of the auger.

18. A bale slicer for mounting on flighting of an auger of an agricultural mixer apparatus with a cutting knife to be moved by rotation of the auger about a rotation axis in an interior of a tub of the apparatus, the bale slicer comprising:
a base portion configured to mount on the flighting of the auger in a first plane oriented substantially parallel to a plane defined by the flighting at a location at which the bale slicer is mounted on the flighting when the bale slicer is mounted on the flighting to contact plant material located in the interior of the tub between the outer edge of the flighting and the perimeter wall of the tub a knife plane of the cutting knife; and
a slicer portion forming a serrated slicer edge, the slicer edge being located in a slicer plane of the slicer portion;
wherein the slicer plane of the slicer edge is angled upwardly at a slicer angle with respect to the knife plane such that the slicer edge is angled upwardly with respect to the flighting when the base portion is mounted on the flighting to contact plant material moving laterally outward with respect to the rotation axis and relative to an upper surface of the flighting.

19. The bale slicer of claim 18 wherein the slicer angle between the first plane of the base portion and the slicer plane of the slicer portion is approximately 30 degrees to approximately 90 degrees.

20. The bale slicer of claim 18 wherein the slicer portion of the bale slicer includes a mount element and a slicer element having the slicer edge thereon, the slicer element being removably mounted on the mount element.
